(19) United States
(12) Patent Application Publication
(10) Pub. No.: US 2019/0145162 A1
(43) Pub. Date: May 16, 2019

(54) LADDER STRAP STRUCTURE INSTALLABLE ON HIGH/LOW RAIL

(71) Applicant: Tser Wen CHOU, Yorba Linda, CA (US)

(72) Inventor: Tser Wen CHOU, Yorba Linda, CA (US)

(21) Appl. No.: 16/031,967

(22) Filed: Jul. 10, 2018

(30) Foreign Application Priority Data
Nov. 16, 2017 (TW) 106217093

(51) Int. Cl. E06B 9/323; E06B 9/304; E06B 9/307; E06B 9/322; E06B 9/382

(52) U.S. Cl. CPC E06B 9/323; E06B 9/304; E06B 9/382; E06B 9/322; E06B 9/307

(57) ABSTRACT

A ladder strap structure installable on high/low rail includes two vertical straps, multiple horizontal straps and a polygonal control drum. Multiple perforations are formed on the vertical straps at equal intervals. A securing bolt is passed through the perforations of the vertical straps to secure the ladder strap on the polygonal control drum. By means of selecting the perforations positioned at different heights, the ladder strap can be secured on the polygonal control drum according to the height of the high/low blind rails so that the application range of the ladder strap is widened.

### BACKGROUND OF THE INVENTION

### 1. Field of the Invention

The present invention relates generally to a ladder strap structure installable on high/low rail, and more particularly to a ladder strap structure, in which the vertical straps are formed with multiple perforations positioned at different heights. By means of selecting the perforations positioned at different heights, the ladder strap can be secured on the polygonal control drum according to the requirement of the high/low blind rails.

### 2. Description of the Related Art

Conventionally, a ladder strap is securely connected with the polygonal control drum in such a manner that the polygonal control drum is formed with two opposite slots and the ladder strap is wound over the polygonal control drum and then passed through the slots. The passing end of the ladder strap is knotted to secure the ladder strap. However, according to such securing manner, the ladder strap bears the total weight of all the blind slats so that the knot of the ladder strap is quite easy to loosen and detach from the polygonal control drum. Moreover, it is hard to control the size and length of the knot so that the length of the ladder strap is hard to control. Especially, when the ladder strap is applied to a high/low blind rail, it is harder for the conventional means to secure the ladder strap to a proper position and it is impossible to control the length of the ladder strap to suit the high or low blind rail.

### SUMMARY OF THE INVENTION

It is therefore a primary object of the present invention to provide a ladder strap structure installable on high/low rail, in which the vertical straps are formed with multiple perforations positioned at different heights. According to the requirement of arrangement of the high/low blind rails, the perforations positioned at different heights on the ladder strap can be selected. In cooperation with the securing holes of the polygonal control drum, a securing bolt can be used to secure the ladder strap on the polygonal control drum for operating and rotating the blind slats. The ladder strap structure is applicable to both a high rail and a lower rail.

To achieve the above and other objects, the ladder strap structure installable on high/low rail of the present invention mainly includes two vertical straps, multiple horizontal straps and a polygonal control drum. Multiple perforations are formed on the vertical straps at equal intervals. The horizontal straps are connected with the two vertical straps for securely connecting with the blind slats. The polygonal control drum is a hexagonal drum body or an octagonal drum body. Two opposite outer plane faces of the drum body are formed with two through holes corresponding to the perforations of the vertical straps. A securing bolt can be inserted through the perforations of the vertical straps into the through holes of the polygonal control drum to secure the vertical straps on the polygonal control drum, whereby the ladder strap can be controlled to ascend or descend.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective view of the ladder strap of the present invention;

FIG. 3 is a perspective view of the ladder strap of the present invention, showing that the ladder strap is connected with a polygonal control drum;

FIG. 4 is a sectional assembled view of the ladder strap of the present invention;

FIG. 5 is a perspective view showing the installation of the ladder strap of the present invention;

FIG. 6 is a side assembled view of the ladder strap of the present invention;

FIG. 7 is a perspective exploded view of another embodiment of the present invention;

FIG. 8 is a perspective assembled view of the other embodiment of the present invention;

FIG. 9 is a side assembled view of the other embodiment of the present invention;

FIG. 10 is a side assembled view showing the operation of the other embodiment of the present invention;

FIG. 11 is another side assembled view showing the operation of the other embodiment of the present invention;

FIG. 12 is a side assembled view of the other embodiment of the present invention in a sunshade state;

FIG. 13 is a perspective view of another embodiment of the horizontal straps of the present invention;

FIG. 14 is a plane view of the other embodiment of the horizontal straps of the present invention;

FIG. 15 is a perspective view of the other embodiment of the horizontal straps of the present invention, showing that the vertical straps are passed through the interior of the loop straps;

FIG. 16 is a perspective assembled view of still another embodiment of the horizontal straps of the present invention; and

FIG. 17 is a plane view of the other embodiment of the horizontal straps of the present invention.

### DETAILED DESCRIPTION OF THE PREFERRED EMBODIMENTS

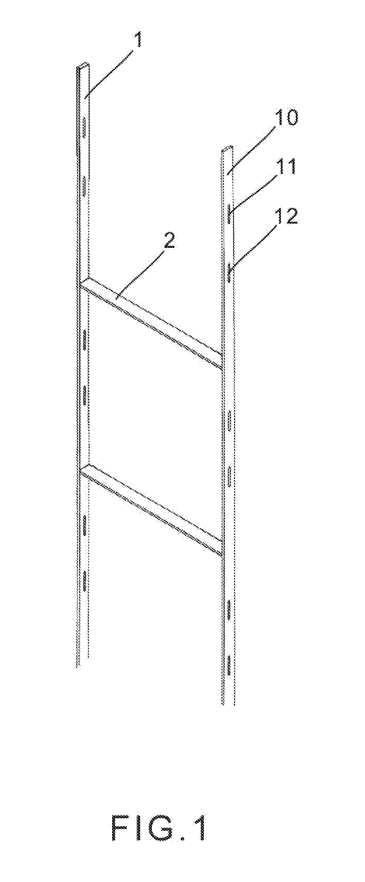

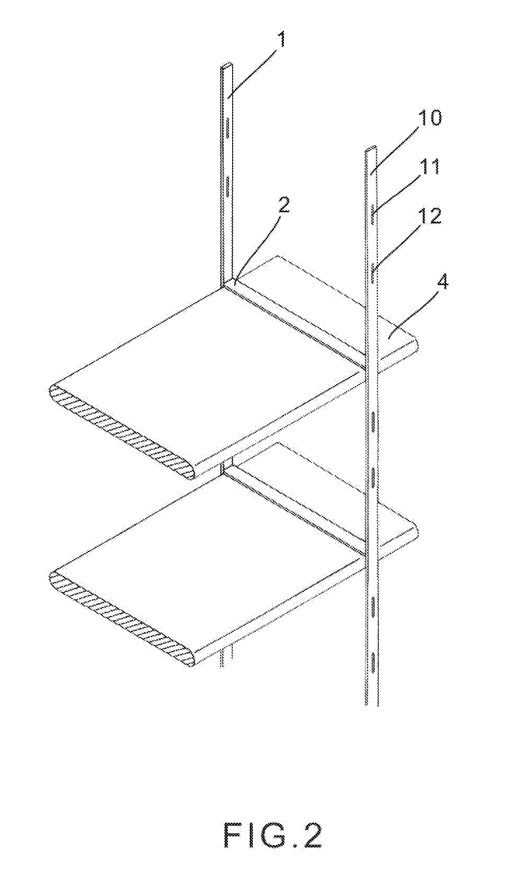

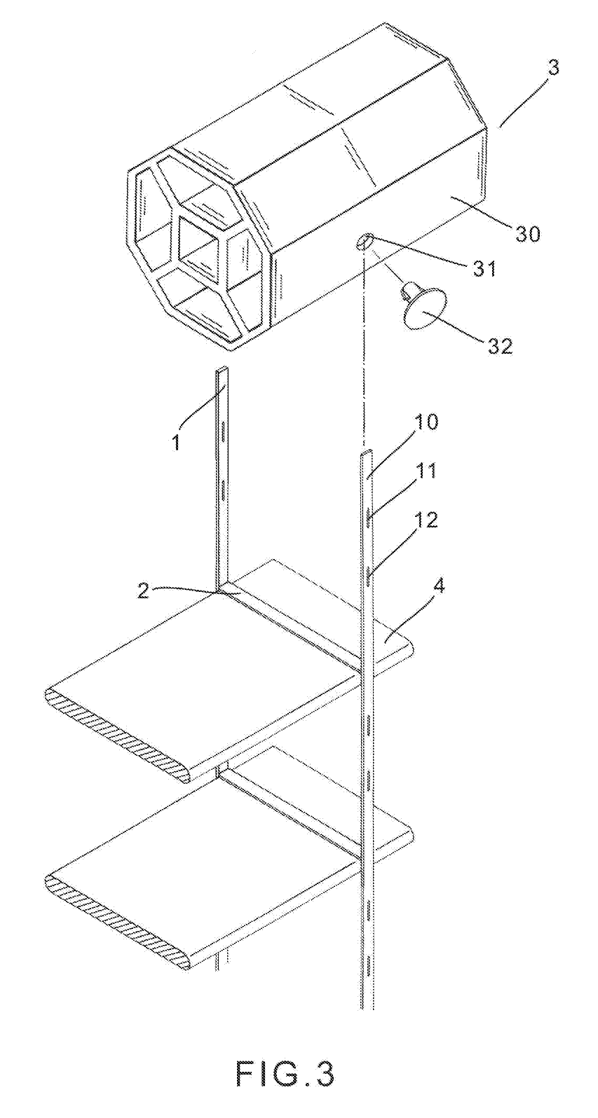

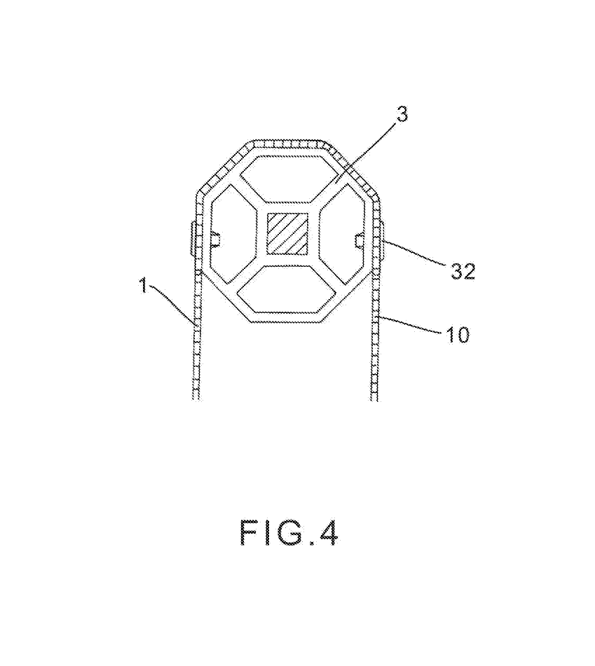

Please refer to FIGS. 1, 2 and 3. The ladder strap structure of the present invention includes two vertical straps 1, 10, multiple horizontal straps 2 connected between the two vertical straps 1, 10 and a polygonal control drum 3. The two vertical straps 1, 10 are formed with multiple perforations 11, 12 arranged at equal intervals or unequal intervals (as shown in FIG. 2). The body 30 of the polygonal control drum 3 is formed with through holes 31 corresponding to the perforations 11, 12. A securing bolt 32 includes a tray body and an engagement shank section extending from the center of the tray body. The engagement shank section of the securing bolt 32 is passed through the perforations 11, 12 and the through hole 31 to secure the vertical straps 1, 10 on the polygonal control drum 3. The horizontal straps 2 are connected between the two vertical straps 1, 10 at equal intervals for connecting with the blind slats 4. Accordingly, by means of rotating the polygonal control drum 3, the vertical straps 1, 10 can be controlled to ascend or descend so as to drivingly turn the blind slats (as shown in FIGS. 3 and 4).

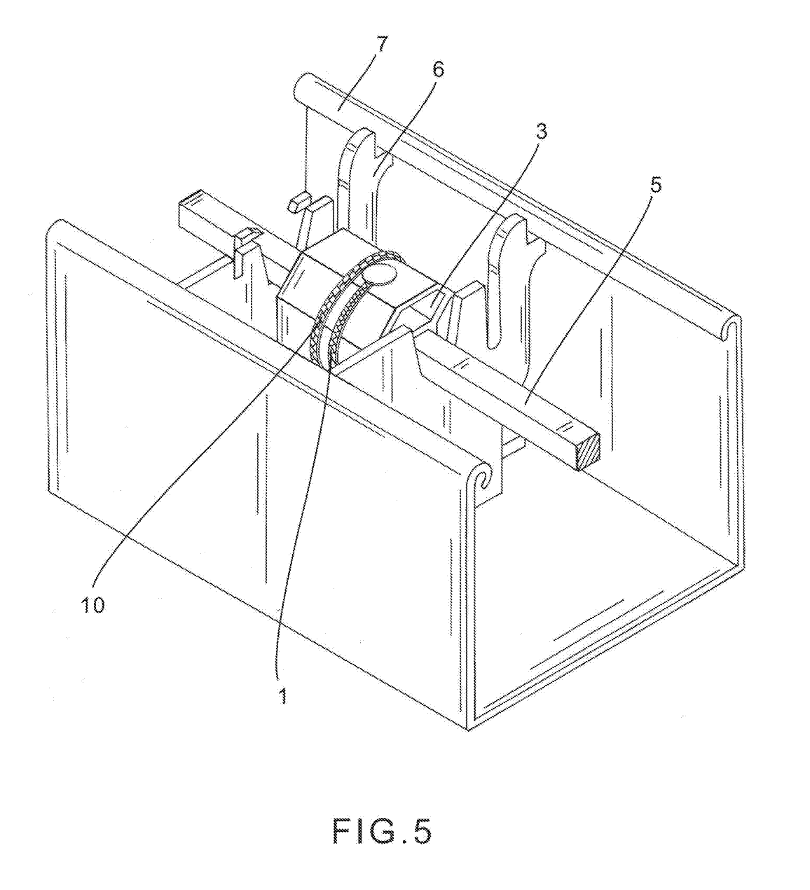

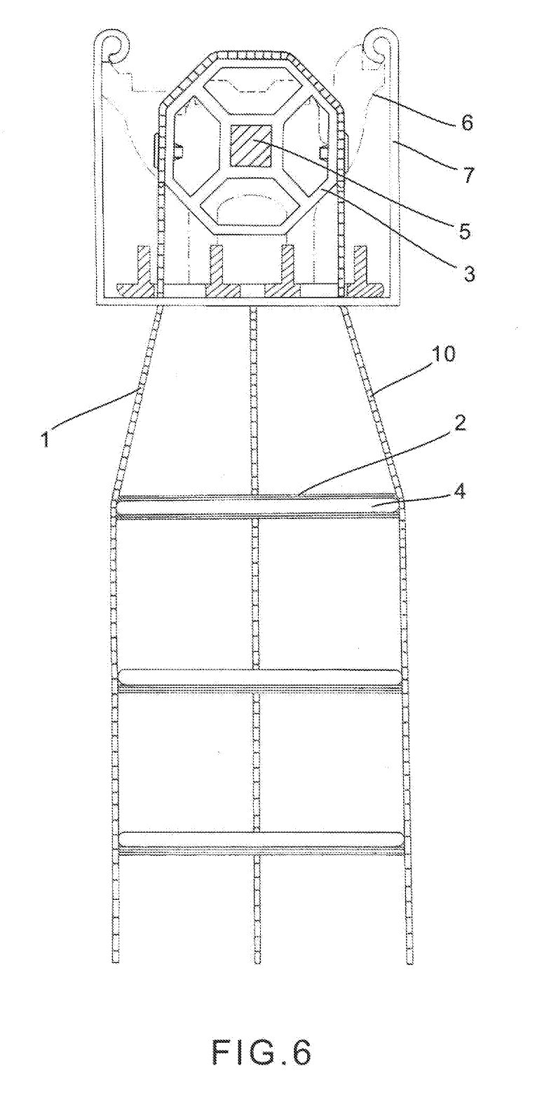

When installed (as shown in FIG. 5), the ladder strap structure is securely disposed on the polygonal control drum 3. Then a quadrangular bar 5 is fitted through and connected with the polygonal control drum 3. Then the polygonal control drum 3 is placed on a fixing seat 6. The fixing seat 6 is connected in a blind rail 7. The two vertical straps 1, 10 are passed through the blind rail 7 and suspended from the blind rail 7. The horizontal straps 2 are connected with the respective blind slats 4 to form a blind control assembly (as shown in FIG. 6).

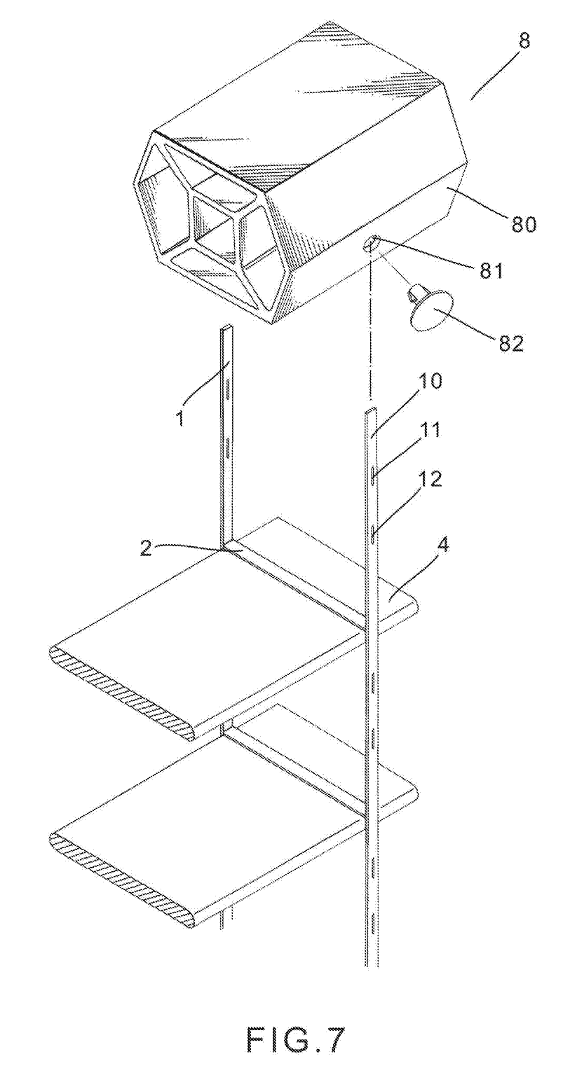

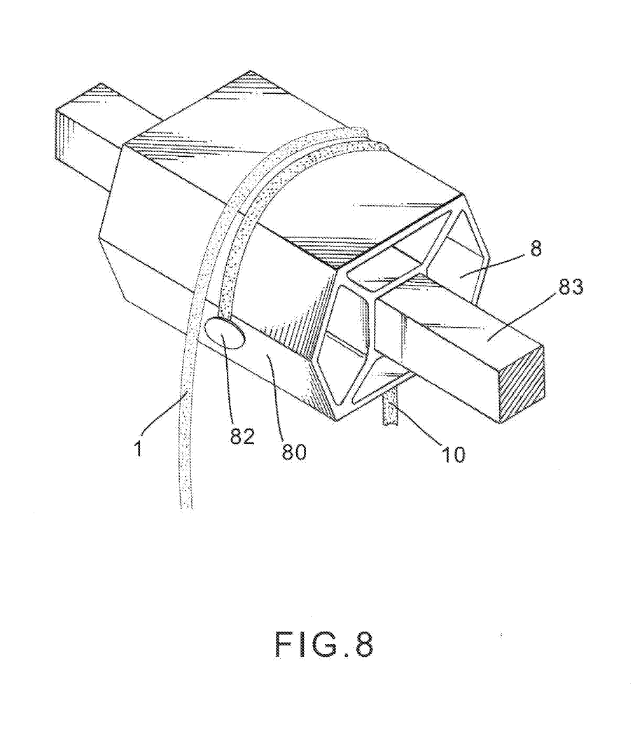

Please now refer to FIG. 7, which shows another embodiment of the polygonal control drum 3 of the present invention. In this embodiment, the polygonal control drum 3 is a hexagonal roller drum 8. The slope sides 80 of the hexagonal roller drum 8 are formed with through holes 81 for securely connecting with the ladder strap structure. The securing bolts 82 are used to integrally connect the ladder strap structure with the hexagonal roller drum 8 (as shown in FIG. 8).

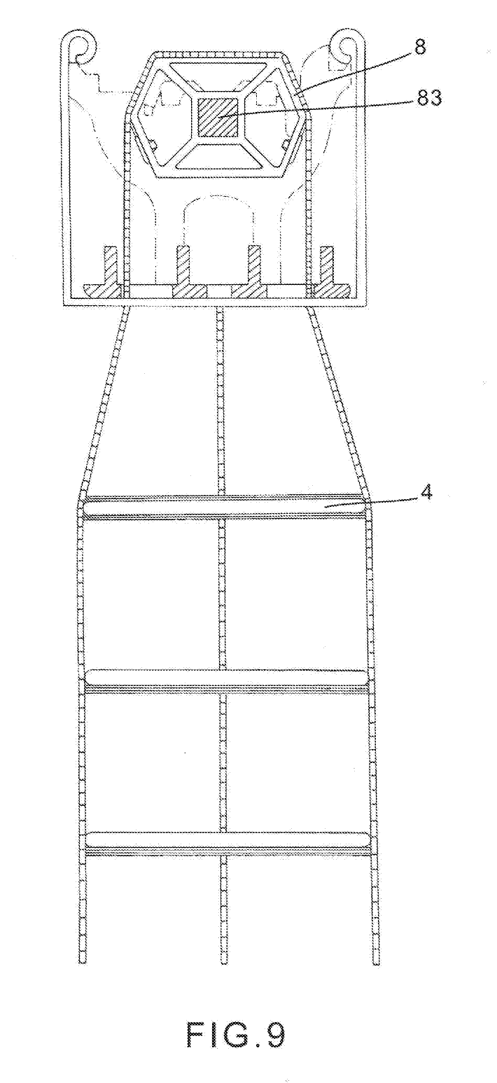

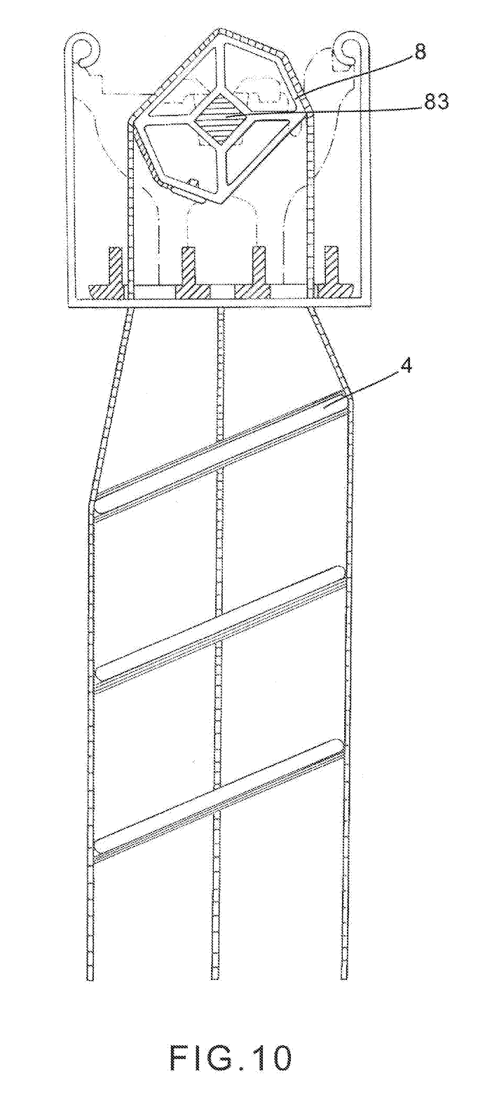

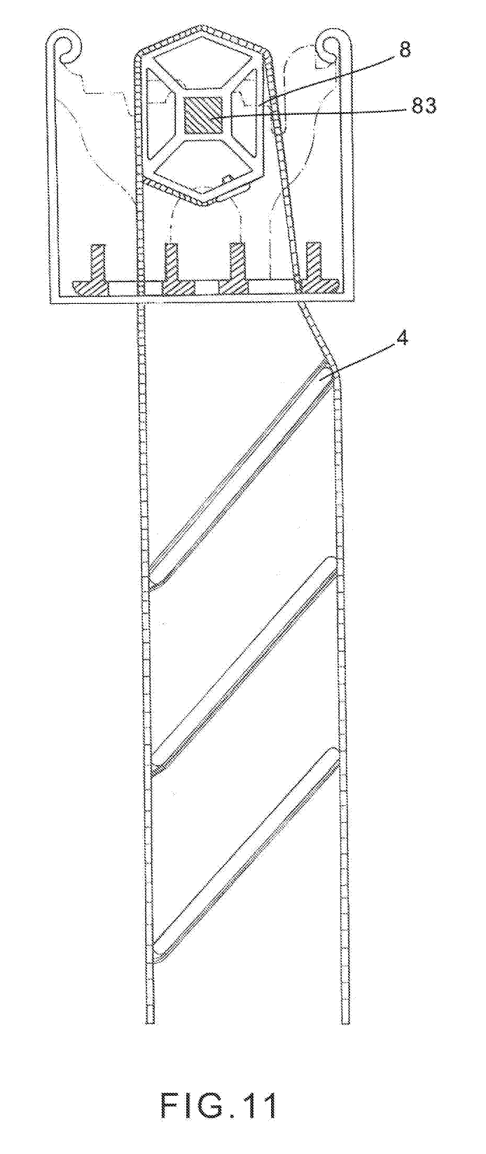

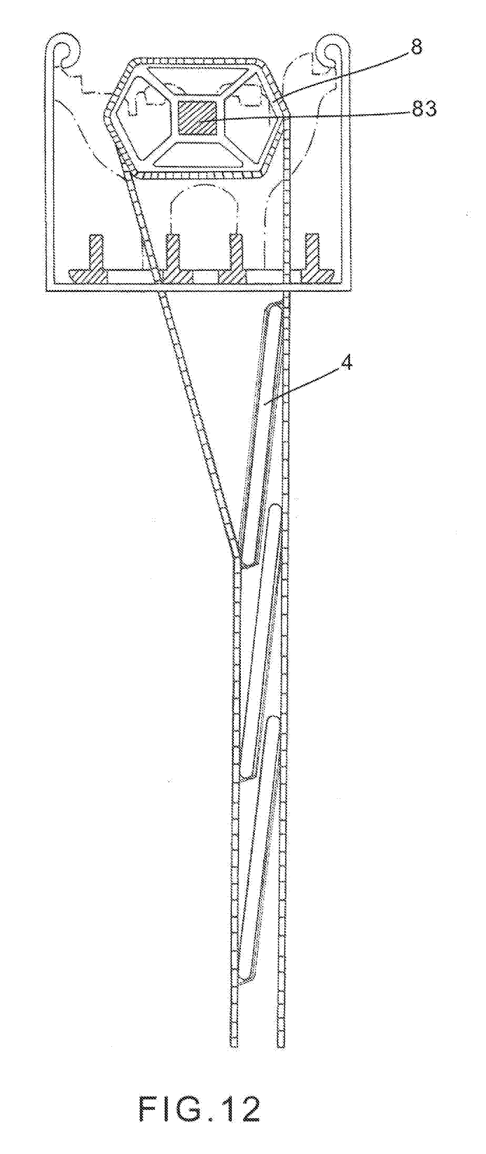

Please now refer to FIGS. 9 to 12. By means of rotating the quadrangular bar 83, the hexagonal roller drum 8 is driven and rotated to control the ladder strap for turning the blind slats 4 so as to achieve sunshade effect.

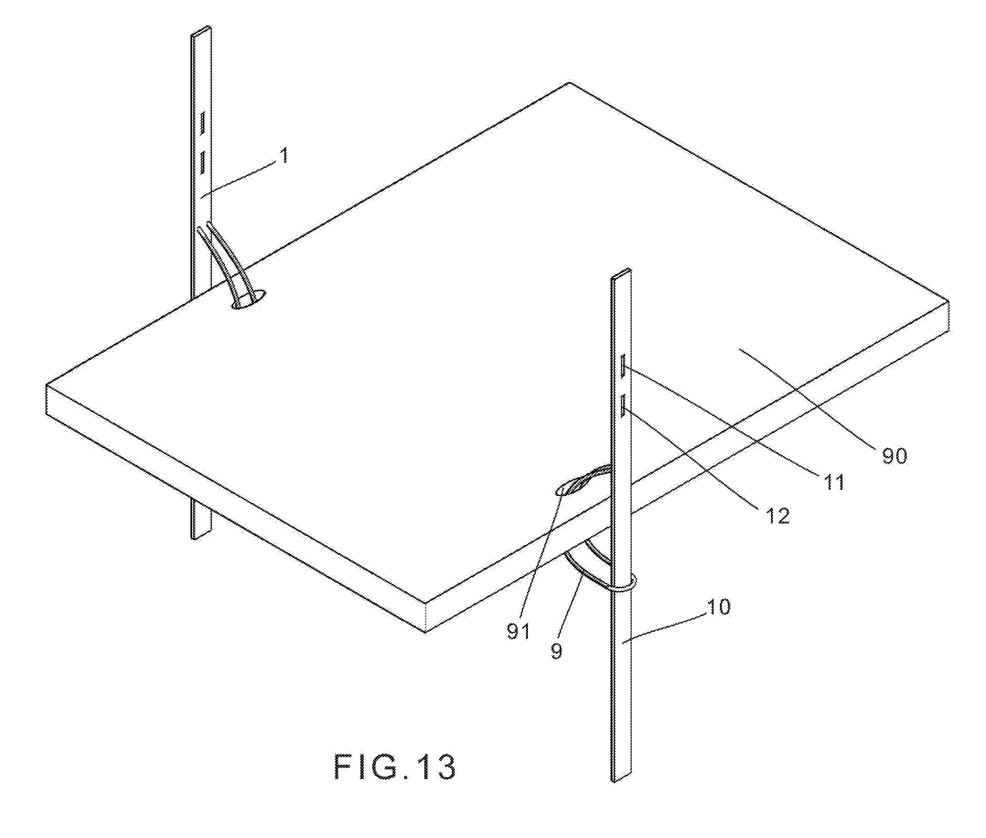

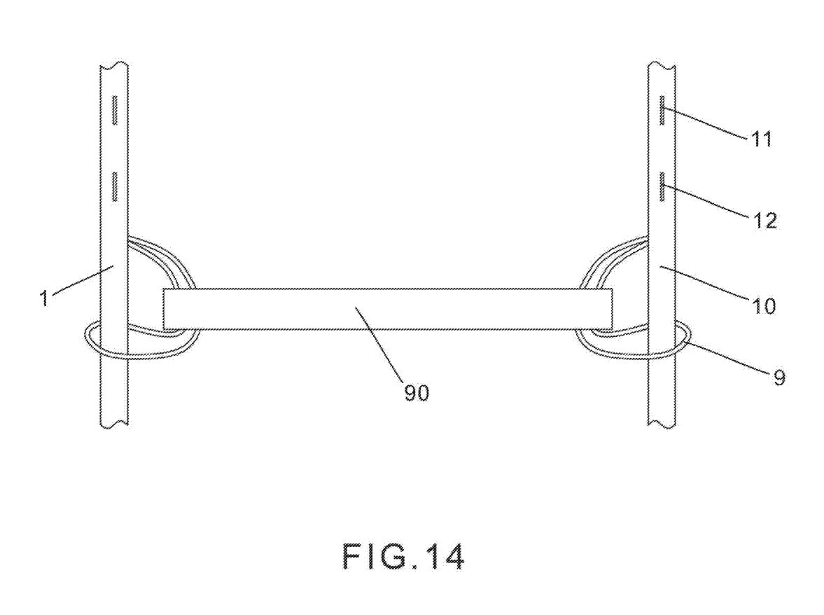

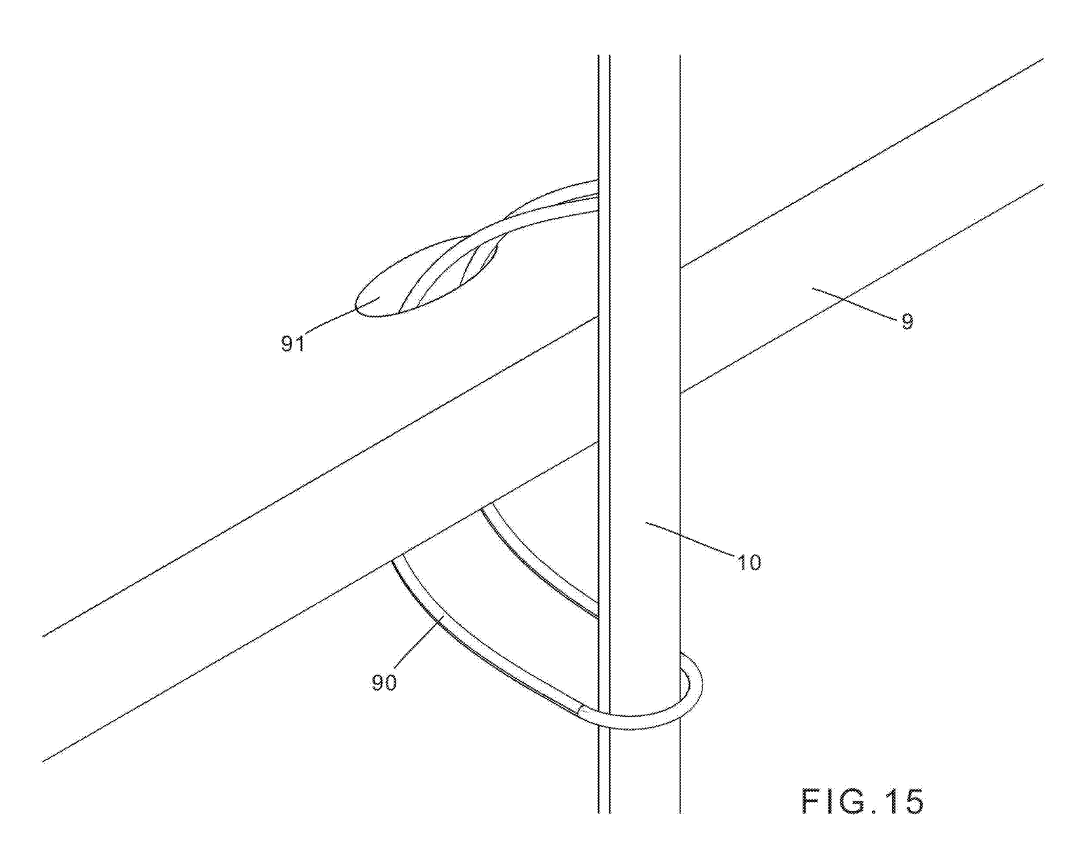

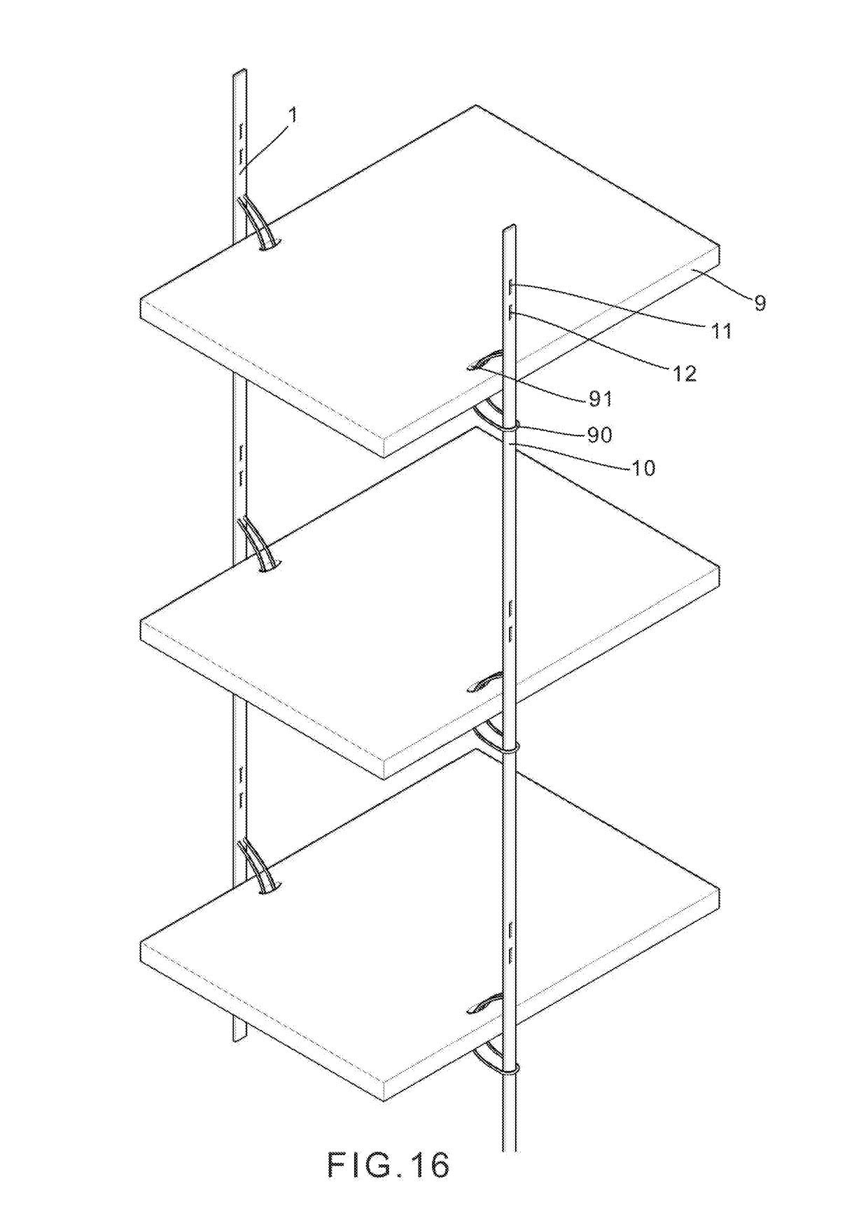

Please now refer to FIGS. 13 and 14, which show another embodiment of the horizontal straps of the present invention. In this embodiment, loop straps 9 are secured to lower sides of the perforations 11, 12 of the vertical straps 1, 10. The loop straps 9 are passed through the perforations 91 formed on the blind slat 90 and the vertical straps 1, 10 are passed through the interior of the loop straps 9, whereby the vertical straps 1, 10 are secured with the blind slat 90 to prevent the blind slat 90 from shaking (as shown in FIGS. 15 and 16).

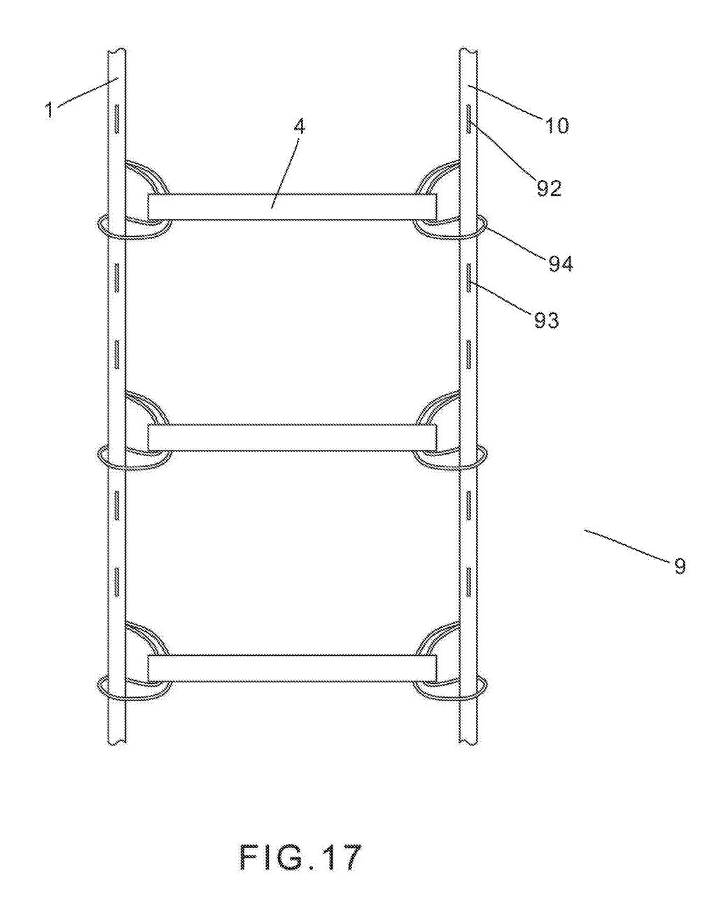

Please now refer to FIG. 17, which shows still another embodiment of the horizontal straps of the present invention. In this embodiment, loop straps 94 are secured between two perforations 92, 93 of the vertical straps 1, 10. The vertical straps 1, 10 are connected with the polygonal control drum via the perforations 92. The loop straps 94 are passed through the perforations of the blind slat and the vertical straps 1, 10 are passed through the interior of the loop straps 94, whereby the vertical straps 1, 10 are securely connected with the blind slat 4.

The above embodiments are only used to illustrate the present invention, not intended to limit the scope thereof. Many modifications of the above embodiments can be made without departing from the spirit of the present invention.

What is claimed is:

1. A ladder strap structure installable on high/low rail, comprising:
two vertical straps formed with multiple perforations;
multiple horizontal straps connected with the two vertical straps and arranged at equal intervals;
a polygonal control drum composed of several plane faces connected with each other to form a hollow drum body, two opposite plane faces of the hollow drum body being respectively formed with two through holes corresponding to the perforations of the vertical straps; and
a securing bolt including a tray body and an engagement shank section extending from a center of the tray body, the engagement shank section of the securing bolt being passed through the perforations of the vertical straps and the through holes of the polygonal control drum to securely disposed the vertical straps at the through holes of the polygonal control drum.

2. The ladder strap structure installable on high/low rail as claimed in claim 1, wherein the horizontal straps are loop straps for connecting with the blind slats.

3. The ladder strap structure installable on high/low rail as claimed in claim 1, wherein the perforations are formed on the vertical straps at equal intervals.
